(19) United States
(12) Patent Application Publication
(10) Pub. No.: US 2026/0177196 A1
(43) Pub. Date: Jun. 25, 2026

(54) ELECTRONIC DIGITAL PHOTO FRAME

(71) Applicant: Shenzhen Joyhong Tech Co.,Ltd, Shenzhen (CN)

(72) Inventor: Jianping Wang, Shenzhen (CN)

(21) Appl. No.: 19/540,706

(22) Filed: Feb. 15, 2026

(30) Foreign Application Priority Data
Jan. 29, 2026 (CN) 202620125742.5

(51) Int. Cl. F16M 11/22; F16M 11/04; F16M 11/10; F16M 11/18

(52) U.S. Cl. CPC F16M 11/22; F16M 11/041; F16M 11/105; F16M 11/18

(57) ABSTRACT

An electronic digital photo frame is provided, including a front cover, a back cover, and a screen assembly. The screen assembly is mounted at a top of the front cover. Two first L-shaped clamping slots and two L-shaped clamping slots jointly form an accommodating cavity. A silicone pad with a protruding outer side is fixedly embedded inside the accommodating cavity. Connection portions of fasteners are integrally formed with the front cover, and clamping portions are provided with guide slopes, so that quick assembling between the front cover and the back cover can be implemented. In addition, protrusions of the clamping portions are adaptively clamped with limiting slots of clamping slots, thus significantly enhancing the stability of connection and avoiding a problem of looseness after long-time use.

### TECHNICAL FIELD

The present disclosure relates to the technical field of electronic photo frames, and specifically to an electronic digital photo frame.

### BACKGROUND

As a smart device for displaying digital photos, a digital photo frame is widely used in home, office, and commercial display scenarios. The stability of a housing structure of the digital photo frame, the convenience of mounting, and the adaptability of use directly affect the user experience.

In the existing technology, front covers and back covers of most digital photo frames are locked by using screws or ordinary fasteners. Locking with the screw needs to be implemented by using a tool, so that the assembling efficiency is low, and it is inconvenient to remove and maintain. Most ordinary fasteners are implemented by simple protrusions cooperating with grooves, so that this lacks guide and limiting structures. After long-time use, the problems of looseness and separation due to vibration or an external force easily occur. Meanwhile, a fixing manner for an existing product is relatively monotonous, which typically supports placement on a stand or hanging on a wall only. This fails to meet requirements of users for magnetically attracting the product on a refrigerator, a metal storage rack, and other scenarios. In addition, to achieve slippage prevention and scratch prevention, an adhesive silicone pad that easily falls off and has poor fitness is designed at a corner of a housing in most cases. As a result, the product has insufficient stability during placement. It is easy to scratch a surface of the housing. This imperceptibly restrains the user experience and market competitiveness of the digital photo frame.

### SUMMARY

The present disclosure aims to provide an electronic digital photo frame, to solve the problems mentioned in the background section.

To achieve the above objective, the present disclosure provides the following technical solution: an electronic digital photo frame includes a front cover, a back cover, and a screen assembly. The screen assembly is mounted at a top of the front cover.

The front cover and the back cover are connected to each other through one-to-one corresponding snap-fit through fasteners and clamping slots. The clamping slots are formed in an edge of the back cover. The fasteners are integrally formed at an edge of the front cover. A plurality of magnet mounting slots are formed in the back cover. A magnet is fixedly embedded inside each magnet mounting slot. First L-shaped clamping slots are formed in three corners of the front cover. Second L-shaped clamping slots that are aligned one by one with the first L-shaped clamping slots of the front cover are formed in three corners of the back cover. After the front cover and the back cover are completely fastened, two first L-shaped clamping slots and second L-shaped clamping slots that are correspondingly aligned with each other jointly form an accommodating cavity. A silicone pad with a protruding outer side is fixedly embedded inside the accommodating cavity.

In a preferred solution of the present disclosure, the fasteners are elastic cantilever-type fasteners. Each fastener includes a connection portion and a clamping portion. One end of the connection portion is integrally formed with the edge of the front cover, while another end of the connection portion is fixedly connected to the clamping portion. A guide slope is arranged at an end portion of the clamping portion. A protrusion is arranged on a side wall of the clamping portion. The protrusion is adaptively clamped with a limiting slot on an inner side of the clamping slot.

In a preferred solution of the present disclosure, the plurality of magnet mounting slots are uniformly distributed inside the back cover, and a depth of each magnet mounting slot matches a thickness of the magnet.

In a preferred solution of the present disclosure, a contour of the silicone pad matches a contour of the accommodating cavity formed by the first L-shaped clamping slots and the second L-shaped clamping slots. A thickness of the silicone pad is greater than a depth of the accommodating cavity by 0.2 mm to 0.5 mm. An outer surface of the silicone pad is provided with antiskid lines. A positioning protrusion is arranged on an inner side of the silicone pad. The positioning protrusion is adaptively clamped with positioning holes on inner sides of the first L-shaped clamping slots and the second L-shaped clamping slots.

In a preferred solution of the present disclosure, the screen assembly includes a screen body and a screen stand. An annular mounting step is arranged on an inner side of the front cover. The screen stand is embedded inside the annular mounting step and is fixedly connected to the front cover. The screen body is fixedly mounted on the screen stand. A display surface of the screen body is flush with a front surface of the front cover.

In a preferred solution of the present disclosure, both the front cover and the back cover are made of acrylonitrile butadiene styrene (ABS) engineering plastic. A scratch-resistant coating is arranged on a front surface of the front cover. A matte texture is arranged on an outer surface of the back cover.

Compared with the prior art, the present disclosure has the beneficial effects:

1) The connection portions of the fasteners are integrally formed with the front cover, and the clamping portions are provided with the guide slopes, so that quick assembling between the front cover and the back cover can be implemented. In addition, the protrusions of the clamping portions are adaptively clamped with the limiting slots of the clamping slots, thus significantly enhancing the stability of connection and avoiding a problem of looseness after long-time use. The antiskid protrusions are arranged in the magnet mounting slots inside the back cover, so that the magnets can be firmly fixed and prevented from moving and falling off. Due to the design of a recessed region, magnetic attraction fixing is more in line with a metal surface, so that the usage scenario of a product is expanded. The first L-shaped clamping slots and the second L-shaped clamping slots of the front cover and the back cover form the accommodating cavity. The silicone pad is fixed through the positioning protrusion and the positioning hole, and the thickness of the silicone pad is slightly greater than the depth of the accommodating cavity, so that a friction force of placement can be effectively increased, a housing can be prevented from being scratched, and the stability and durability of the product can be enhanced.

2) The screen assembly of the present disclosure cooperates with the screen stand through the annular mounting step, so that the display surface of the screen body is flush with the front surface of the front cover, and the visual experience is enhanced. The scratch-resistant coating of the front cover and the matte texture of the back cover enhance the wear resistance performance and grip feel of the housing and effectively improves the assembling efficiency, use stability, and user experience of the digital photo frame.

### BRIEF DESCRIPTION OF THE DRAWINGS

FIG. 1 is a schematic diagram of a structure of the present disclosure;

FIG. 2 is a first schematic diagram of a structure of the present disclosure;

FIG. 3 is a schematic exploded diagram of the present disclosure;

FIG. 4 is a first schematic exploded diagram of the present disclosure;

FIG. 5 is a schematic diagram of a structure of a front cover of the present disclosure;

FIG. 6 is an enlarged view of part A in FIG. 5 of the present disclosure;

FIG. 7 is a partially schematic diagram of a structure of the present disclosure;

FIG. 8 is a schematic diagram of a structure of a back cover of the present disclosure; and

FIG. 9 is an enlarged view of part B in FIG. 8 of the present disclosure.

In the drawings: 100: front cover; 110: first L-shaped clamping slot; 120: fastener; 121: connection portion; 122: clamping portion; 123: guide slope; 124: protrusion; 130: annular mounting step; 140: scratch-resistant coating; 200: back cover; 210: second L-shaped clamping slot; 211: positioning hole; 220: clamping slot; 221: limiting slot; 230: magnet mounting slot; 240: magnet; 250: matte texture; 300: screen assembly; 310: screen body; 320: screen stand; 400: accommodating cavity; 500: silicone pad; and 510: positioning protrusion.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are merely some embodiments of the present disclosure, rather than all of the embodiments. All other embodiments obtained by a person of ordinary skill in the art based on the embodiments of the present disclosure without making creative efforts shall fall within the protection scope of the present disclosure.

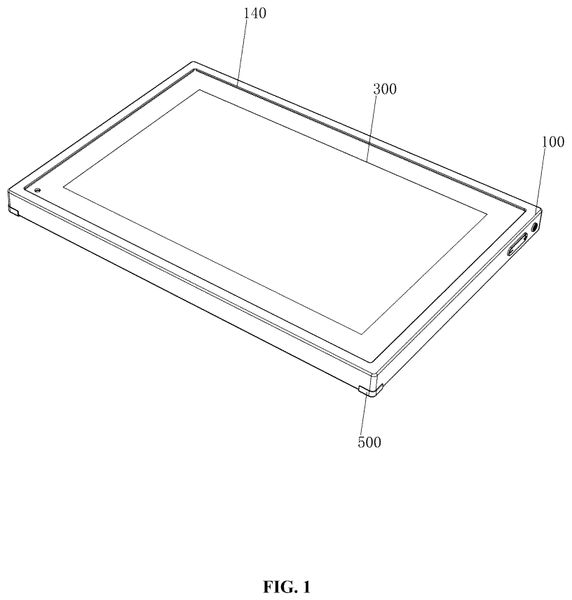

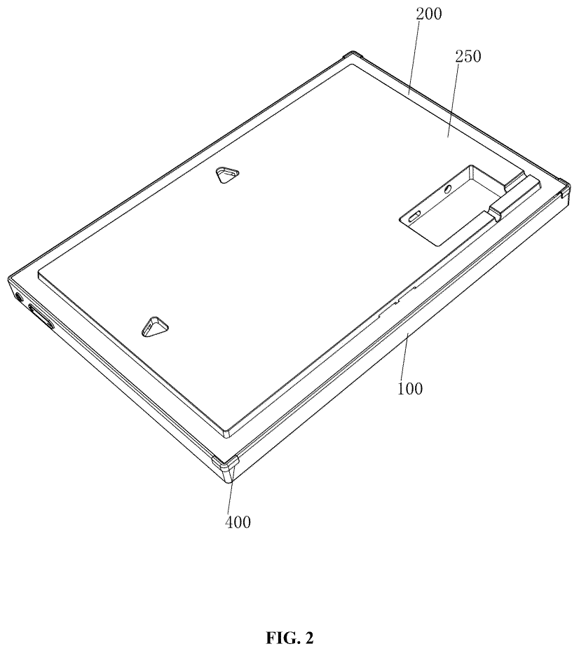

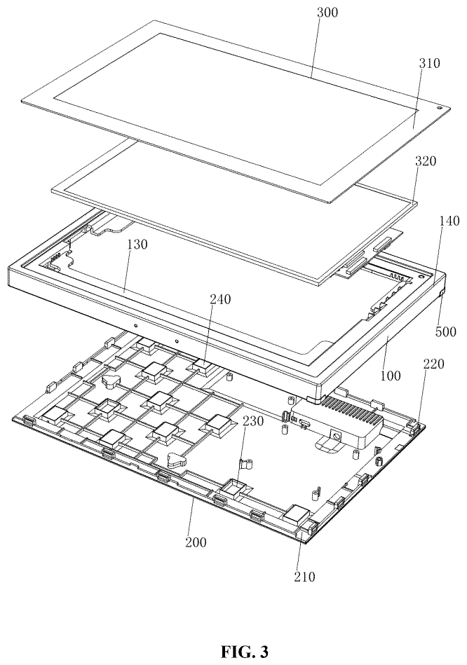

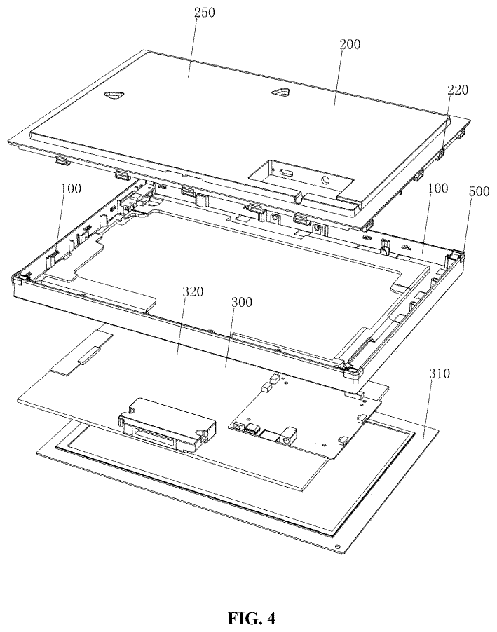

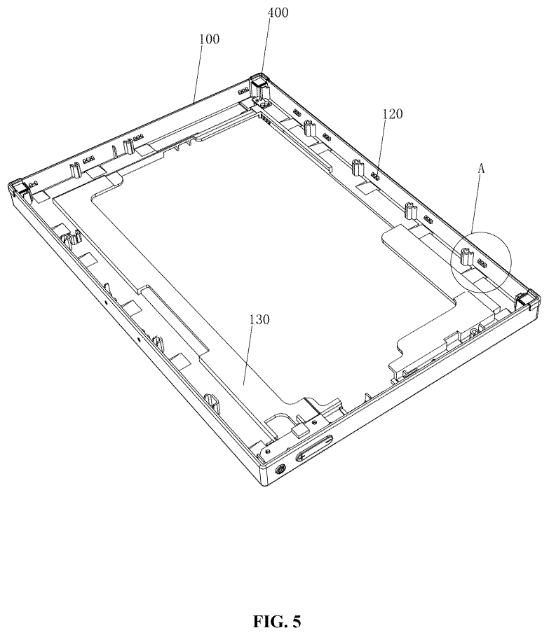

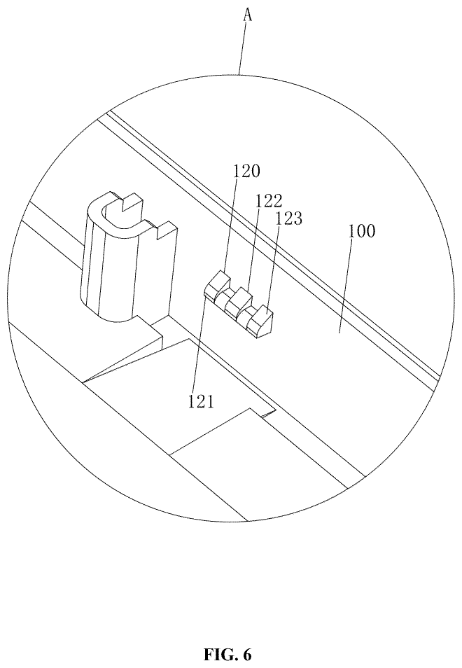

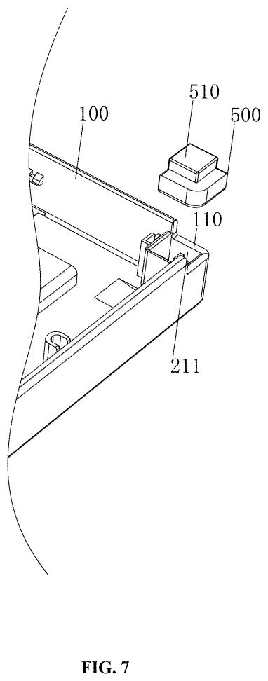

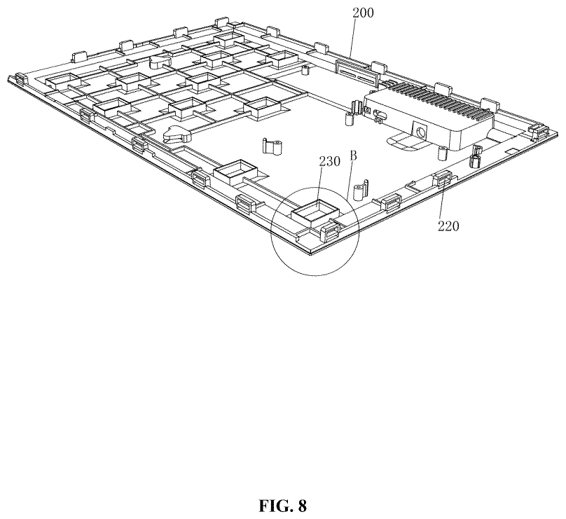

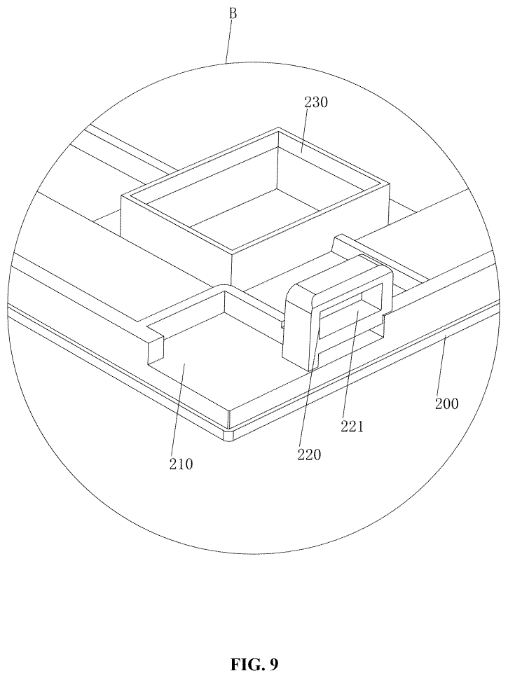

Referring to FIG. 1 to FIG. 9, the present disclosure provides a technical solution: an electronic digital photo frame includes a front cover 100, a back cover 200, and a screen assembly 300. The screen assembly 300 is mounted at a top of the front cover 100.

The front cover 100 and the back cover 200 are connected to each other through one-to-one corresponding snap-fit between fasteners 120 and clamping slots 220. The clamping slots 220 are formed in an edge of the back cover 200. The fasteners 120 are integrally formed at an edge of the front cover 100. A plurality of magnet mounting slots 230 are formed in the back cover 200. A magnet 240 is fixedly embedded inside each magnet mounting slot 230. First L-shaped clamping slots 110 are formed in three corners of the front cover 100. Second L-shaped clamping slots 210 that are aligned one by one with the first L-shaped clamping slots 110 of the front cover 100 are formed in three corners of the back cover 200. After the front cover 100 and the back cover 200 are completely fastened, two first L-shaped clamping slots 110 and second L-shaped clamping slots 210 that are correspondingly aligned with each other jointly form an accommodating cavity 400. A silicone pad 500 with a protruding outer side is fixedly embedded inside the accommodating cavity 400.

Specifically, during assembling, the screen assembly 300 is fixedly mounted at the top of the front cover 100 to complete positioning and assembling of the screen assembly 300, to ensure that a mounting position of the screen assembly 300 is accurate and stable. Then, the fasteners 120 integrally formed at the edge of the front cover 100 are aligned with the clamping slots 220 formed in the edge of the back cover 200 in a one-to-one correspondence manner, and the front cover 100 and the back cover 200 are gently pressed by an external force to smoothly snap the fasteners 120 into the clamping slots 220, thus quickly achieving the fixed connection between the front cover 100 and the back cover 200 without an additional tool and enhancing the assembling efficiency.

During use, the magnets 240 fixedly embedded inside the plurality of magnet mounting slots 230 formed inside the back cover 200 can generate a stable magnetic attraction force with a metal fixing surface of a refrigerator, a metal storage rack, or the like, thereby magnetically fixing the entire electronic digital photo frame to a metal surface and enriching the use scenario of the product.

After the front cover 100 and the back cover 200 are completely fastened, the first L-shaped clamping slots 110 at the three corners of the front cover 100 can be aligned with the second L-shaped clamping slots 210 at the three corners of the back cover 200 in the one-to-one correspondence manner, thus jointly forming the intact accommodating cavity 400. The silicone pad 500 with the protruding outer side, which is fixedly embedded inside the accommodating cavity 400, can be in full contact with a placement surface when the product is placed. This increases a contact friction force to prevent the product from slipping, and can avoid corners of the front cover 100 and the back cover 200 from being in contact with the placement surface, thus effectively preventing the surface of the housing from being scratched and improving the durability of the product.

In this embodiment, the fasteners 120 are elastic cantilever-type fasteners. Each fastener 120 includes a connection portion 121 and a clamping portion 122. One end of the connection portion 121 is integrally formed with the edge of the front cover, while another end of the connection portion is fixedly connected to the clamping portion 122. A guide slope 123 is arranged at an end portion of the clamping portion 122. A protrusion 124 is arranged on a side wall of the clamping portion 122. The protrusion 124 is adaptively clamped with a limiting slot 221 on an inner side of the clamping slot 220.

Specifically, each fastener 120 adopts an elastic cantilever-type structural design. One end of the connection portion 121 is integrally formed with the edge of the front cover 100, and another end of the connection portion is fixedly connected to the clamping portion 122, so that the fastener 120 has a good elastic deformation ability, and it is convenient for assembling and disassembling.

In an assembling process of the front cover 100 and the back cover 200, the guide slope 123 is arranged at the end portion of the clamping portion 122, so that the fastener 120 can be effectively guided to smoothly slide into the clamping slot 220, thus greatly reducing the assembling resistance between the fastener 120 and the clamping slot 220, avoiding the occurrence of jamming, locking, or damage to the fastener 120 during the assembling, and further improving the convenience of assembling. After the fastener 120 is completely clamped into the clamping slot 220, the protrusion 124 arranged on the side wall of the clamping portion 122 can be accurately adaptively clamped with the limiting slot 221 formed in the inner side of the clamping slot 220. Through a mutual limiting effect of the protrusion 124 and the limiting slot 221, the up, down, left, and right movement of the fastener 120 in the clamping slot 220 is limited, thus effectively preventing a phenomenon that the fastener 120 is detached from the clamping slot 220 because of vibration, collision with an external force, and other factors in the long-time use process, further enhancing the stability and reliability of the connection between the front cover 100 and the back cover 200, and ensuring the overall structural firmness of the product.

In this embodiment: the plurality of magnet mounting slots 230 are uniformly distributed inside the back cover 200, and a depth of each magnet mounting slot 230 matches a thickness of the magnet 240.

Specifically, the plurality of magnet mounting slots 230 are uniformly distributed inside the back cover 200, so that magnetic attraction forces generated by the magnets 240 fixedly embedded in the magnet mounting slots 230 are uniformly distributed on an entire back surface f the back cover 200. This ensures that when the electronic digital photo frame is magnetically fixed on a metal surface, the back cover 200 is uniformly stressed, thus avoiding problems such as fixed tilting and detachment due to non-uniform local forces, and ensuring the stability of magnetic fixation. The depth of each magnet mounting slot 230 accurately matches the thickness of magnet 240, so that the magnet 240 can be completely embedded into the magnet mounting slot 230. This avoids the magnet 240 from protruding from a surface of the magnet mounting slot 230, to ensure the flatness of an internal structure of the back cover 200 and prevent the magnet 240 from being bumped, worn, or damaged due to protrusion, and ensures that the magnet 240 is in close fit with an inner wall of the magnet mounting slot 230, to reduce the shaking of the magnet 240 inside the magnet mounting slot 230, ensure stable outputting of a magnetic attraction force, and ensure that the product can be stably fixed for a long time in a magnetic-attraction use scenario, and meet a user need.

In this embodiment: a contour of the silicone pad 500 matches a contour of the accommodating cavity 400 formed by the first L-shaped clamping slots 110 and the second L-shaped clamping slots 210. A thickness of the silicone pad 500 is greater than a depth of the accommodating cavity 400 by 0.2 mm to 0.5 mm. An outer surface of the silicone pad 500 is provided with antiskid lines. A positioning protrusion 510 is arranged on an inner side of the silicone pad 500. The positioning protrusion 510 is adaptively clamped with positioning holes 211 on inner sides of the first L-shaped clamping slots 110 and the second L-shaped clamping slots 210.

Specifically, after the front cover 100 and the back cover 200 are completely fastened, the first L-shaped clamping slots 110 and the second L-shaped clamping slots 210 jointly form the accommodating cavity 400. The contour of the silicone pad 500 precisely matches the contour of the accommodating cavity 400. It can ensure that the silicone pad 500 is tightly embedded into the accommodating cavity 400, avoid formation of a gap between the silicone pad 500 and the accommodating cavity 400, and prevent the silicone pad 500 from being loosened or moving during use.

The thickness of the silicone pad 500 is greater than the depth of the accommodating cavity 400 by 0.2 mm to 0.5 mm. It can allow the outer side of the silicone pad 500 to protrude slightly after the silicone pad is embedded into the accommodating cavity 400, thus ensuring that the silicone pad 500 can be in full contact with the placement surface and fully exert its antiskid effect when the product is placed. The antiskid lines provided on the outer surface of the silicone pad 500 further increase the friction force between the silicone pad 500 and the placement surface, thus enhancing the stability of placement of the product and avoiding accidental slippage of the product. Meanwhile, the positioning protrusion 510 arranged on the inner side of the silicone pad 500 can accurately match the positioning holes 211 on the inner sides of the first L-shaped clamping slots 110 and the second L-shaped clamping slots 210, thus achieving firm fixation of the silicone pad 500 inside the accommodating cavity 400, preventing the silicone pad 500 from falling off, and ensuring long-term stability of the antiskid and scratch-resistant effects.

In this embodiment: the screen assembly 300 includes a screen body 310 and a screen stand 320. An annular mounting step 130 is arranged on an inner side of the front cover 100. The screen stand 320 is embedded inside the annular mounting step 130 and is fixedly connected to the front cover 100. The screen body 310 is fixedly mounted on the screen stand 320. A display surface of the screen body 310 is flush with a front surface of the front cover 100.

Specifically, during assembling, the screen stand 320 is first embedded into the annular mounting step 130 arranged on the inner side of the front cover 100. The screen stand 320 is precisely positioned and limited by the annular mounting step 130 to ensure that the mounting position of the screen stand 320 is not offset. Then, the screen stand 320 is fixedly connected to the front cover 100 to complete stable assembling of the screen stand 320. Afterwards, the screen body 310 is fixedly mounted on the screen stand 320. The screen stand 320 can stably support and protect the screen body 310 to avoid direct contact between the screen body 310 and the front cover 100, as well as the back cover 200, thus preventing the screen body 310 from being damaged by pressing and collision during assembling or use.

The display surface of the screen body 310 is flush with the front surface of the front cover 100, thus avoiding protrusion or depression of the screen body 310. This enhances the visual aesthetics of the product and prevents the screen body 310 from protruding and being scratched, thus ensuring a watching experience of a user.

In this embodiment: both the front cover 100 and the back cover 200 are made of ABS engineering plastic. A scratch-resistant coating 140 is arranged on a front surface of the front cover 100. A matte texture 250 is arranged on an outer surface of the back cover 200.

Specifically, both the front cover 100 and the back cover 200 are made of the ABS engineering plastic. The ABS engineering plastic has good structural strength, toughness, and wear resistance, so that it ensures that the front cover 100 and the back cover 200 can withstand a slight external force during daily use, thus avoiding easy breakage and deformation of the front cover 100 and the back cover 200 and effectively enhancing the structural stability and durability of the entire electronic digital photo frame. Meanwhile, the production costs of the ABS engineering plastic is moderate, making it easy for mass production of the product and reducing the production investment. The scratch-resistant coating 140 is arranged on the front surface of the front cover 100. The scratch-resistant coating 140 can comprehensively cover the front surface of the front cover 100 and can effectively withstand slight scratching during daily use, prevent the front surface of the front cover 100 from being scratched and worn, and keep the appearance of the product neat and attractive.

The matte texture 250 is arranged on the outer surface of the back cover 200. The matte texture 250 can increase a friction force on the outer surface of the back cover 200. In one aspect, it is convenient for a user to grasp the product without slippage, to enhance the grip feel. In another aspect, this can increase a friction force between the product and the placement surface when the product is placed, thus further improving the stability of placement of the product. Meanwhile, it can also reduce fingerprint contamination and facilitate daily cleaning.

Content that is not described in detail in this specification belongs to the existing technology known to those skilled in the art. Although the present disclosure has been described in detail with reference to the foregoing embodiments, those skilled in the art can still make modifications to the technical solutions described in the foregoing respective embodiments or make equivalent replacements to some technical features therein. Any modification, equivalent replacement, improvement, and the like made within the spirit and principle of the present invention shall fall within the protection scope of the present disclosure.

What is claimed is:

1. An electronic digital photo frame, comprising a front cover (100), a back cover (200), and a screen assembly (300), wherein the screen assembly (300) is mounted at a top of the front cover (100);
the front cover (100) and the back cover (200) are connected to each other through one-to-one corresponding snap-fit between fasteners (120) and clamping slots (220); the clamping slots (220) are formed in an edge of the back cover (200); the fasteners (120) are integrally formed at an edge of the front cover (100); a plurality of magnet mounting slots (230) are formed in the back cover (200); a magnet (240) is fixedly embedded inside each magnet mounting slot (230); first L-shaped clamping slots (110) are formed in three corners of the front cover (100); second L-shaped clamping slots (210) that are aligned one by one with the first L-shaped clamping slots (110) of the front cover (100) are formed in three corners of the back cover (200); after the front cover (100) and the back cover (200) are completely fastened, two first L-shaped clamping slots (110) and second L-shaped clamping slots (210) that are correspondingly aligned with each other jointly form an accommodating cavity (400); and a silicone pad (500) with a protruding outer side is fixedly embedded inside the accommodating cavity (400).

2. The electronic digital photo frame according to claim 1, wherein the fasteners (120) are elastic cantilever-type fasteners; each fastener (120) comprises a connection portion (121) and a clamping portion (122); one end of the connection portion (121) is integrally formed with the edge of the front cover, while another end of the connection portion is fixedly connected to the clamping portion (122); a guide slope (123) is arranged at an end portion of the clamping portion (122); a protrusion (124) is arranged on a side wall of the clamping portion (122); and the protrusion (124) is adaptively clamped with a limiting slot (221) on an inner side of the clamping slot (220).

3. The electronic digital photo frame according to claim 1, wherein the plurality of magnet mounting slots (230) are uniformly distributed inside the back cover (200), and a depth of each magnet mounting slot (230) matches a thickness of the magnet (240).

4. The electronic digital photo frame according to claim 1, wherein a contour of the silicone pad (500) matches a contour of the accommodating cavity (400) formed by the first L-shaped clamping slots (110) and the second L-shaped clamping slots (210); a thickness of the silicone pad (500) is greater than a depth of the accommodating cavity (400) by 0.2 mm to 0.5 mm; an outer surface of the silicone pad (500) is provided with antiskid lines; a positioning protrusion (510) is arranged on an inner side of the silicone pad (500); and the positioning protrusion (510) is adaptively clamped with positioning holes (211) on inner sides of the first L-shaped clamping slots (110) and the second L-shaped clamping slots (210).

5. The electronic digital photo frame according to claim 1, wherein the screen assembly (300) comprises a screen body (310) and a screen stand (320); an annular mounting step (130) is arranged on an inner side of the front cover (100); the screen stand (320) is embedded inside the annular mounting step (130) and is fixedly connected to the front cover (100); the screen body (310) is fixedly mounted on the screen stand (320); and a display surface of the screen body (310) is flush with a front surface of the front cover (100).

6. The electronic digital photo frame according to claim 1, wherein both the front cover (100) and the back cover (200) are made of acrylonitrile butadiene styrene (ABS) engineering plastic; a scratch-resistant coating (140) is arranged on a front surface of the front cover (100); and a matte texture (250) is arranged on an outer surface of the back cover (200).
